(19) United States
(12) Patent Application Publication
(10) Pub. No.: US 2012/0105607 A1
(43) Pub. Date: May 3, 2012

(54) Image Display System and Image Display Method Thereof

(75) Inventor: Tzung-Ren Wang, Sinshih Township (TW)

(73) Assignee: HIMAX TECHNOLOGIES LIMITED, Sinshih Township (TW)

(21) Appl. No.: 12/917,035

(22) Filed: Nov. 1, 2010

(51) Int. Cl. H04N 13/04

(52) U.S. Cl. 348/53; 348/51; 348/E13.075

(57) ABSTRACT

An image display system and image display method thereof. The image display system includes a multimedia receiving port, a 3D content detection engine, a format converter and an image display device. The multimedia receiving port is operative to receive a video signal. The 3D content detection engine analyzes one image of the video signal to determine whether the video signal includes 3D content. When the 3D content detection engine determines that the video signal includes 3D content, the format converter is enabled to convert the video signal into a 3D format, to display 3D video on the image display device. When no 3D content is contained in the received video signal, the format converter is not enabled, and the image display device displays the non-format converted video signal.

### BACKGROUND OF THE INVENTION

1. Field of the Invention

The present invention relates to an image display system supporting a 3D display tech and more particularly to detection of 3D content.

2. Description of the Related Art

In conventional techniques, a high-end communication protocol, such as HDMI 1.4, is required in an image display system to receive a 3D video. By the headers of the communication signal, the image display system can recognize whether a received video signal includes 3D content.

However, a high-end communication interface is generally high-priced and, for the video provider, a considerable license fee for high-bandwidth digital content protection (HDCP) may be required. A need has risen to propose a system/method for detecting 3D content via a low-end communication interface, such as DVI (digital video interactive) or D-sub (D-subminiature) interfaces.

### BRIEF SUMMARY OF THE INVENTION

The invention discloses an image display system and an image display method thereof.

An image display system in accordance with an exemplary embodiment of the invention comprises a multimedia receiving port, a 3D content detection engine, a format converter and an image display device. The multimedia receiving port is operative to receive a video signal. The 3D content detection engine analyzes one image of the video signal to determine whether the video signal includes 3D content. When the 3D content detection engine determines that the video signal includes 3D content, the format converter is enabled to convert the video signal into a 3D format, and the format converted video signal is displayed by the image display device. When no 3D content is contained in the received video signal, the format converter is not enabled, and the image display device displays the non-format converted video signal.

In an exemplary embodiment, the 3D content detection engine comprises a left/right image boundary detector, operative to search for a left/right image boundary from the analyzed image. The video signal may be determined as including 3D content when the left/right image boundary detector obtains a left/right image boundary from the image.

In another exemplary embodiment, the 3D content detection engine comprises a similarity checker in addition to the left/right image boundary detector. When the left/right image boundary detector has searched one candidate for the left/right image boundary, the similarity checker is enabled to check similarity between a probable left image and a probable right image. When the similarity between the probable left and right images is greater than a threshold, the video signal may be determined as including 3D content.

An image display system in accordance with an exemplary embodiment of the invention further comprises an infrared receiving port. The infrared receiving port is operative to receive infrared output from an infrared transmitter of 3D glasses, and the infrared receiving port is coupled to the format converter. The format converter may be further enabled when the infrared output from the infrared transmitter of the 3D glasses indicates that the user has put on the 3D glasses. Thus, the received video signal would be converted to the 3D format to show 3D video on the image display device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates an image display system in accordance with an exemplary embodiment of the invention;

FIG. 2 illustrates a 3D content detection engine in accordance with an exemplary embodiment of the invention;

FIGS. 3A and 3B depict embodiments of searching a left/right image boundary and checking similarity between the probable left and right images, wherein the 3D mode under consideration is a side-by-side mode;

FIGS. 4A and 4B depict embodiments of searching a left/right image boundary and checking similarity between the probable left and right images, wherein the 3D mode under consideration is a top and bottom mode;

FIG. 5 shows a 3D glasses in accordance with the invention;

FIG. 6 is a flowchart, depicting an image display method in accordance with an exemplary embodiment of the invention; and

FIG. 7 is a flowchart, depicting a video signal analysis in accordance with an exemplary embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

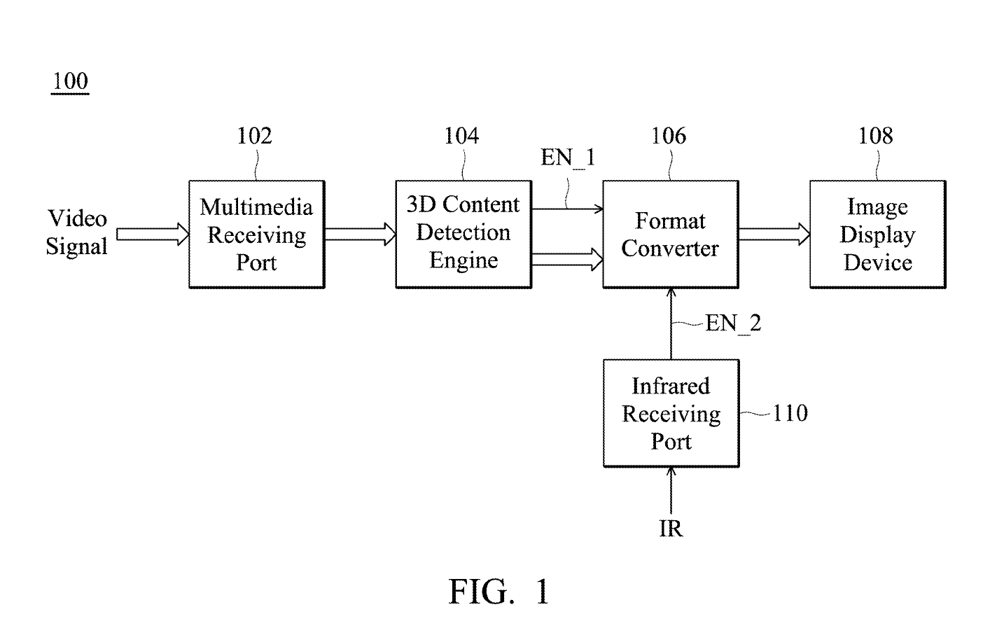

FIG. 1 illustrates an image display system 100 in accordance with an exemplary embodiment of the invention. The image display system 100 comprises a multimedia receiving port 102, a 3D content detection engine 104, a format converter 106, an image display device 108 and an infrared receiving port 110.

The display system 100 receives a video signal via the multimedia receiving port 102. The received video signal is conveyed to the 3D content detection engine 104. The 3D content detection engine 104 analyzes one image of the video signal to determine whether the video signal includes 3D content. When the 3D content detection engine 104 determines that the video signal includes 3D content, the 3D content detection engine 104 enables the format converter 106 via an enable signal EN_1 to convert the video signal into a 3D format (e.g., red/cyan, line-by-line or frame sequence which are respectively for red/cyan glasses, polarization glasses or shutter glasses), and the format converter 106 outputs the format converted video signal to be displayed by the image display device 108. Oppositely, when the 3D content detection engine 104 determines that the video signal does not include 3D content, the format converter 106 is not enabled for format conversion and purely conveys the non-format converted video signal to be shown on the image display device 108. The image display device 108 may be an LCD, a projector, and so on.

In comparison with the conventional techniques, the image display system 100 does not require a high-end communication protocol to provide headers in the communication signal to indicate whether the received video signal includes 3D content. Instead, the image display system 100 determines whether the received video signal includes 3D content by the 3D content detection engine 104 which analyzes one image of the received video signal. Thus, the multimedia receiving port 102 is not limited to a high-end communication interface (e.g. HDMI 1.4), and may be realized by low cost interfaces such as DVI or D-sub interfaces.

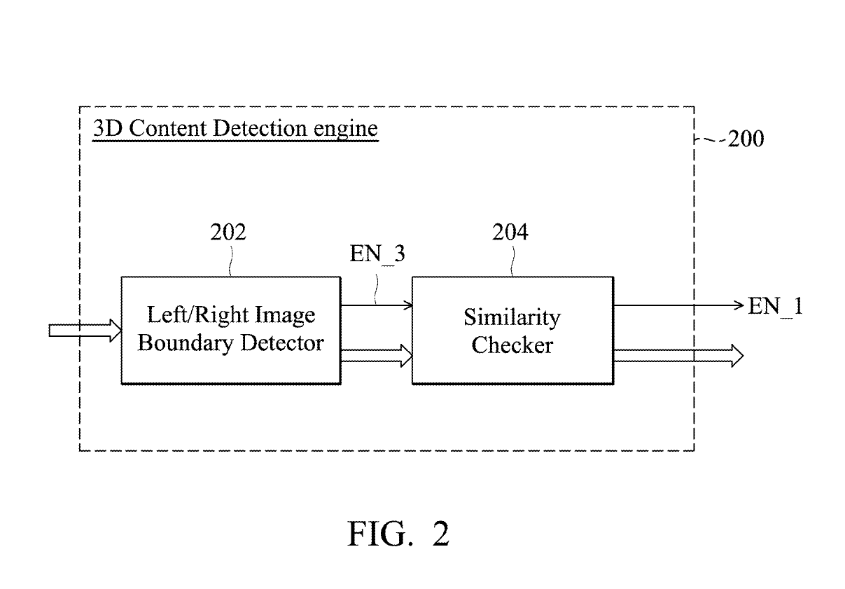

FIG. 2 illustrates a 3D content detection engine 200 in accordance with an exemplary embodiment of the invention. The 3D content detection engine 200 comprises a left/right image boundary detector 202 and a similarity checker 204. The left/right image boundary detector 202 searches for a left/right image boundary from the image that is being analyzed. The similarity checker 204 is coupled after the left/right image boundary detector 202, and is enabled by an enable signal En_3 when the left/right image boundary detector 202 has obtained one candidate for the left/right image boundary. Based on the boundary candidate, a probable left image and a probable right image can be obtained. The enabled similarity checker 204 checks the similarity between the probable left and right images. When the similarity between the probable left and right images is greater than a threshold, the video signal is determined as including 3D content.

The similarity checker 204 is optional. In other embodiments, the video signal may be determined as including 3D content just based on the left/right image boundary detected by the left/right image boundary detector 202.

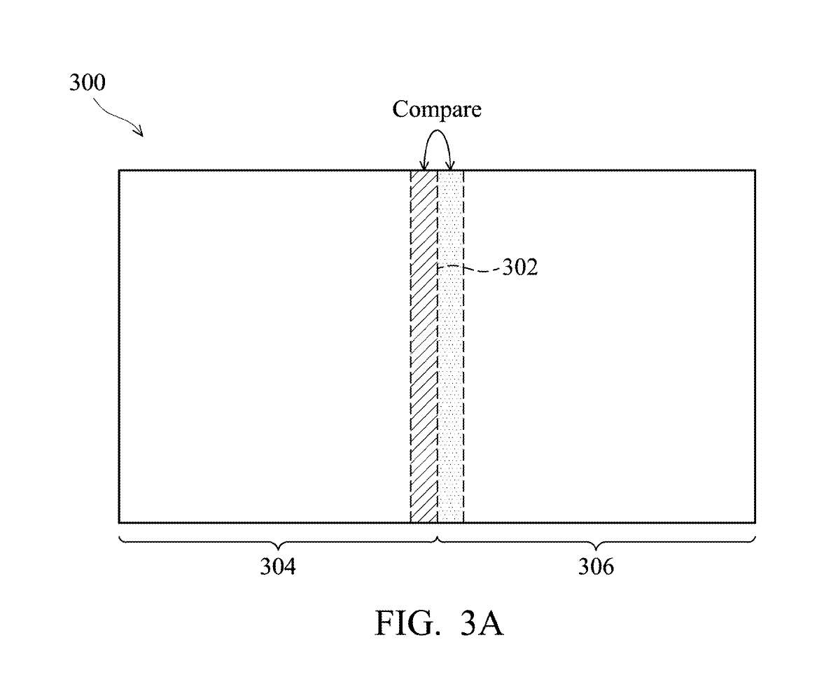

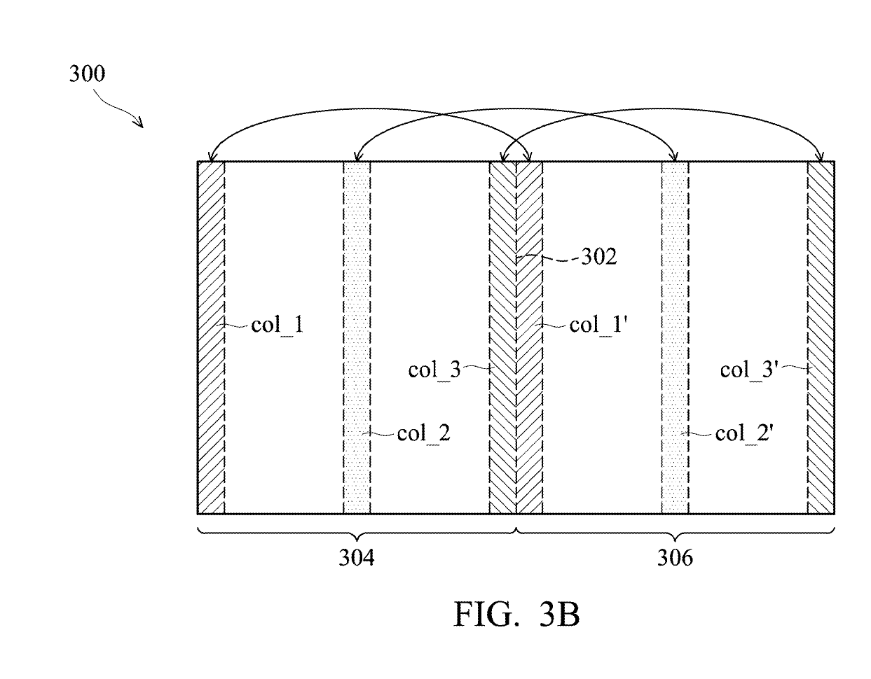

This paragraph discusses a 3D content detection technique for side-by-side 3D content. FIG. 3A depicts the operations of the left/right image boundary detector 202. As shown, to recognize the side by side 3D content, a dividing line 302 is provided and the image 300 is divided into two partitions 304 and 306 according to the dividing line 302. By comparing the pixels on opposite sides of the dividing line 302, incoherence between the two partitions 304 and 306 is measured. When the incoherence between the two partitions 304 and 306 is obvious, the received video signal may be determined as including side-by-side 3D content. In this regard, the dividing line 302 may be determined as the left/right image boundary, and the partition 304 and the partition 306 are regarded as a left image and a right image, respectively.

To further ensure the recognition of 3D content, a similarity check is introduced and shown in FIG. 3B (relating to the similarity checker 204 of FIG. 2). In such a case, the dividing line 302 is regarded as a candidate for the left/right image boundary, while partitions 304 and 306 are regarded as a probable left image and a probable right image, respectively. In FIG. 3B, three columns col_1, col_2 and col_3 of the probable left image 304 are picked out to be compared with three columns col_1′, col_2′ and col_3′ of the probable right image 306. Columns col_1, col_2 and col_3 are the first column, the middle one and the last column of the probable left image 304. Columns col_1′, col_2′ and col_3′ are the first column, the middle one and the last column of the probable right image 306. When the columns col_1 and col_1′ are of high similarity, the columns col_2 and col_2′ are of high similarity and the columns col_3 and col_3′ are of high similarity, it can be asserted that the received video signal includes side-by-side 3D content.

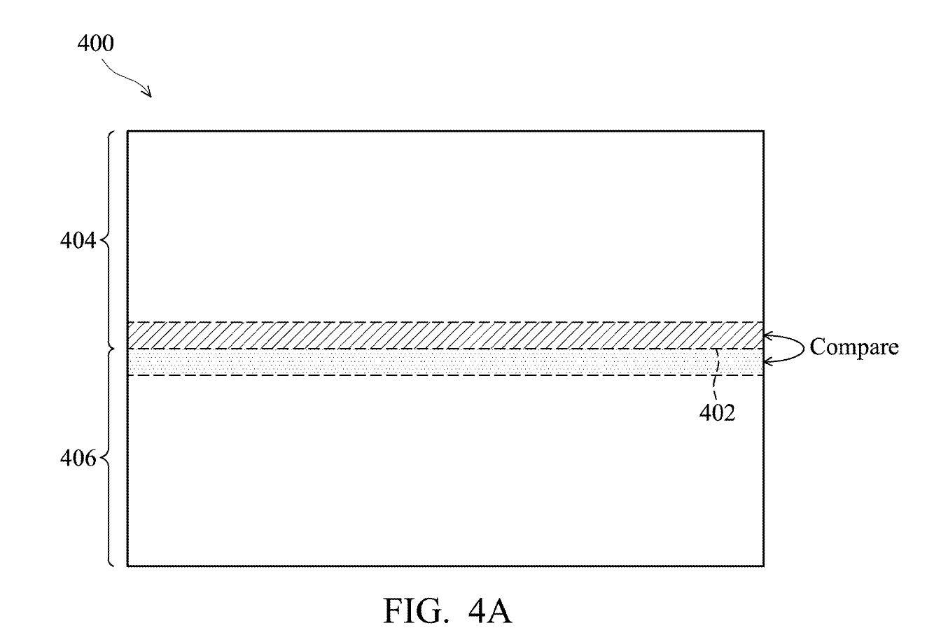

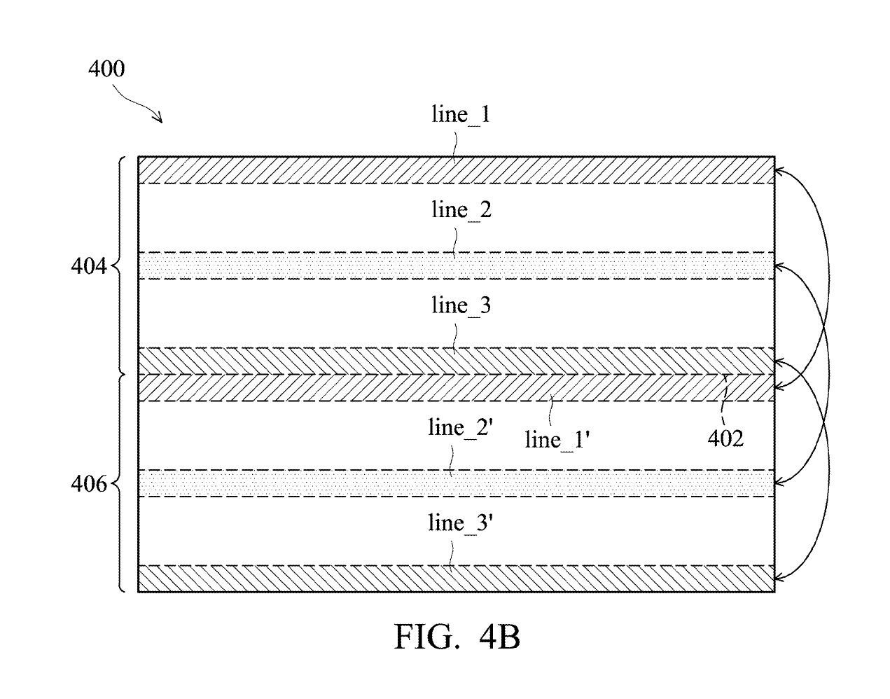

This paragraph discusses a 3D content detection technique for top and bottom 3D content. FIG. 4A depicts the operations of the left/right image boundary detector 202. As shown, to recognize the top and bottom 3D content, a dividing line 402 is provided and the image 400 is divided into two partitions 404 and 406 according to the dividing line 402. By comparing the pixels on opposite sides of the dividing line 402, incoherence between the two partitions 404 and 406 is measured. When the incoherence between the two partitions 404 and 406 is obvious, the received video signal may be determined as including top and bottom 3D content. In this regard, the dividing line 402 may be determined as the left/right image boundary, and the partition 404 and the partition 406 are regarded as a left image and a right image, respectively.

To further ensure the recognition of 3D content of FIG. 4A, a similarity check is introduced and shown in FIG. 4B (relating to the similarity checker 204 of FIG. 2). In such a case, the dividing line 402 is regarded as a candidate for the left/right image boundary, while partitions 404 and 406 are regarded as a probable left image and a probable right image, respectively. In this embodiment, three lines line_1, line_2 and line_3 of the probable left image 404 are picked out to be compared with three lines line_1′, line_2′ and line_3′ of the probable right image 406. Lines line_1, line_2 and line_3 are the first line, the middle one and the last line of the probable left image 404. Lines line_1′, line_2′ and line_3′ are the first line, the middle one and the last line of the probable right image 406. When the lines line_1 and line_1′ are of high similarity, the lines line_2 and line_2′ are of high similarity and the lines line_3 and line_3′ are of high similarity, it is asserted that the received video signal includes top and bottom 3D content.

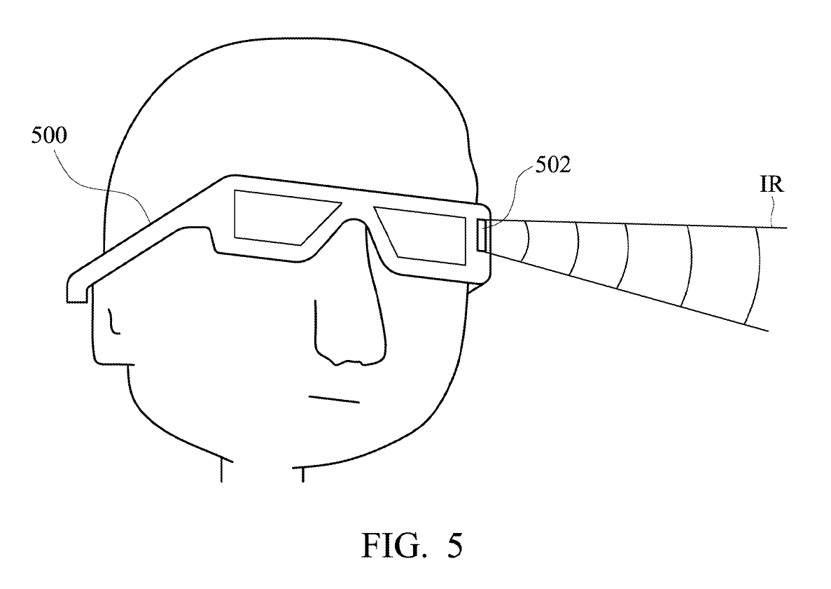

The disclosed image display system may further comprise 3D glasses such as red/cyan glasses, polarization glasses or shutter glasses. FIG. 5 illustrates the 3D glasses. The 3D glasses 500 comprise an infrared transmitter 502. The infrared transmitter 502 may transmit infrared (labeled ‘IR’) when the 3D glasses 500 is in use (e.g. put on the user's nose). Referring back to FIG. 1, the infrared IR may be received by the infrared receiving port 110, to enable the format converter 106 via the enable signal EN_2. The enabled format converter 106 converts the received video signal into the 3D format, so that a 3D video is displayed on the image display device 108. In some embodiments, the IR transmitter 502 stops transmitting the infrared IR when the 3D glasses 500 is folded (not in use).

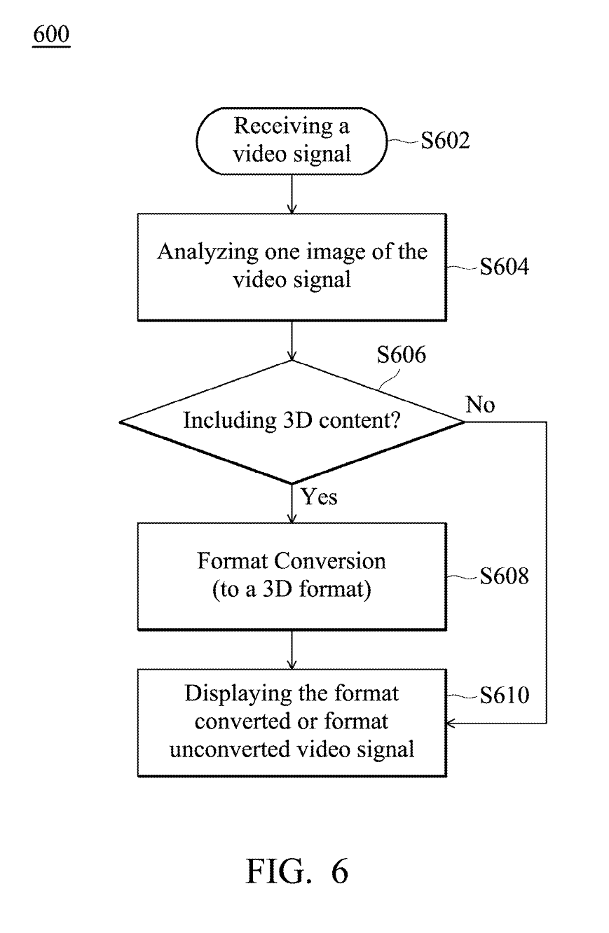

FIG. 6 illustrates a flowchart depicting an image display method in accordance with an exemplary embodiment of the invention. The flowchart 600 starts from step S602, wherein a video signal is received. In step S604, one image of the video signal is analyzed to determine whether the video signal includes 3D content. Depending on the determination made in step S606, step S608 is performed when the video signal includes 3D content, or step S610 is performed when the video signal does not include 3D content. In step S610, image display is performed. When the video signal includes 3D content, format conversion is performed in step S608 to convert the video signal into a 3D format for display in step S610. When the video signal does not include 3D content, the format conversion of step S608 is skipped and the video signal is directly displayed in step S610, so that a conventional 2D video may be shown.

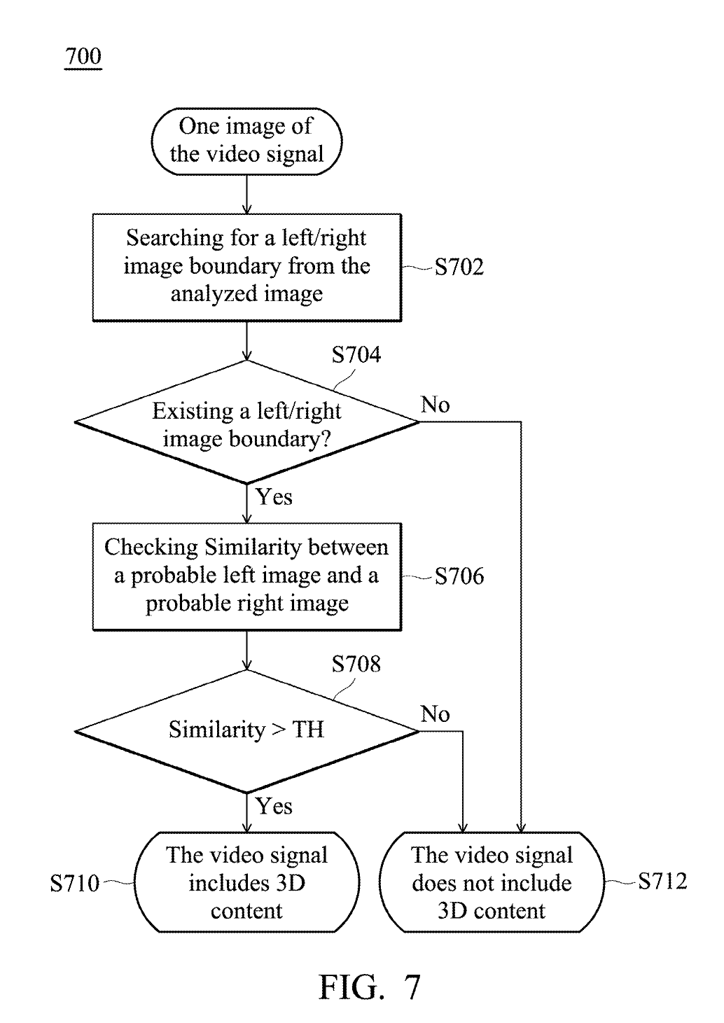

FIG. 7 illustrates a flowchart depicting an exemplary embodiment of the video signal analysis step S604. The procedure is based on one image of a received video signal. In step S702, an image is searched to obtain a left/right image boundary. Depending on the determination made in step S704, when it is determined that the analyzed image contains a candidate for the left/right image boundary, step S706 is performed. In step S706, the similarity between a probable left image and a probable right image are estimated. Depending on the determination made in step S708, when it is determined that the similarity between the probable right and left images is greater than a threshold, a conclusion S710 is made that the video signal includes 3D content. When the decision step S704 determines that the image does not contain any left/right image boundary or in step S708, it is determined that the similarity between the probable left and right images is not greater than a threshold, a conclusion S712 may be made that no 3D content is included in the video signal.

In the flowchart 700, the steps S706 and S708 may be optional and can be omitted from the procedure.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image display system, comprising:
a multimedia receiving port, receiving a video signal;
a 3D content detection engine, analyzing one image of the video signal to determine whether the video signal includes 3D content;
a format converter, enabled to convert the video signal into a 3D format when the 3D content detection engine determines that the video signal includes 3D content; and
an image display device, displaying the video signal of the 3D format when the format converter is enabled, and otherwise, displaying the video signal that is not format converted by the format converter.

2. The image display system as claimed in claim 1, wherein the 3D content detection engine further comprises:
a left/right image boundary detector, searching for a left/right image boundary from the analyzed image.

3. The image display system as claimed in claim 2, wherein the left/right image boundary detector searches for the left/right image boundary by dividing the analyzed image in accordance with a possible 3D mode, and comparing pixels on opposite sides of dividing lines to measure incoherence therebetween.

4. The image display system as claimed in claim 2, wherein the 3D content detection engine further comprises:
a similarity checker, enabled when the left/right image boundary detector has obtained one candidate for the left/right image boundary, to check similarity between a probable left image and a probable right image.

5. The image display system as claimed in claim 4, wherein the 3D detection engine determines that the video signal includes 3D content when the similarity between the probable left and right images is greater than a threshold.

6. The image display system as claimed in claim 1, further comprising:
an infrared receiving port coupled to the format converter, operative to receive an infrared output from an infrared transmitter of 3D glasses; and
the 3D glasses having the infrared transmitter.

7. The image display system as claimed in claim 6, wherein:
the format converter is further enabled when the infrared output from the infrared transmitter of the 3D glasses indicates that the 3D glasses is in use.

8. An image display method, comprising:
receiving a video signal;
analyzing one image of the video signal to determine whether the video signal includes 3D content;
performing format conversion when the video signal is determined as including 3D content, to convert the video signal into a 3D format; and
displaying the video signal of the 3D format when the format conversion is performed, and otherwise, displaying the video signal that is not format converted to the 3D format.

9. The image display method as claimed in claim 8, wherein the step of analyzing the video signal further comprises:
searching for a left/right image boundary from the analyzed image.

10. The image display method as claimed in claim 9, wherein the step of searching a left/right image boundary comprises:
dividing the analyzed image in accordance with a possible 3D mode, and
comparing pixels on opposite sides of dividing lines to measure incoherence therebetween.

11. The image display method as claimed in claim 9, wherein the step of analyzing the video signal further comprises:
checking similarity between a probable left image and a probable right image when one candidate for the left/right image boundary has been obtained; and
determining that the video signal includes 3D content when the similarity between the probable left and right images is greater than a threshold.

12. The image display method as claimed in claim 8, further comprising:
receiving an infrared output from an infrared transmitter of 3D glasses; and
performing the format conversion when the infrared output from the infrared transmitter of the 3D glasses indicates that the 3D glasses is in use.
